(19) United States
(12) Patent Application Publication
(10) Pub. No.: US 2016/0180300 A1
(43) Pub. Date: Jun. 23, 2016

(54) METHOD AND APPARATUS FOR MANAGING DIGITAL RECEIPTS

(71) Applicant: ProxToMe, San Francisco, CA (US)

(72) Inventor: Andrea MOTTO, San Francisco, CA (US)

(21) Appl. No.: 14/975,245

(22) Filed: Dec. 18, 2015

Related U.S. Application Data
(60) Provisional application No. 62/094,668, filed on Dec. 19, 2014.

(51) Int. Cl. G06Q 20/04; H04W 4/00; G06Q 20/20

(52) U.S. Cl. CPC G06Q 20/0453; G06Q 20/202; G06Q 20/209; H04W 4/008

(57) ABSTRACT

A method and apparatus may include transmitting receipt data to a server. The receipt data reflects a receipt of a completed sales transaction. The method may also include providing an identifier to a mobile application of a customer of the sales transaction. The mobile application is configured to retrieve the receipt data from the server using the provided identifier.

### BACKGROUND

1. Field

Certain embodiments of the present invention may relate to the management of digital receipts.

2. Description of the Related Art

A receipt may be an acknowledgment that a commercial transaction has been completed. For example, a receipt may be an acknowledgment that an item or payment has been received. A receipt is generally printed/generated at the point of sale or time of sale of the commercial transaction. Receipts have traditionally been presented to customers in paper form.

### SUMMARY:

According to a first embodiment, a method may include transmitting, by a sales device, receipt data to a server. The receipt data reflects a receipt of a completed sales transaction. The method may also include providing an identifier to a mobile application of a customer of the sales transaction. The mobile application may be configured to retrieve the receipt data from the server using the provided identifier.

In the method of the first embodiment, the providing the identifier may include providing an identifier of the sales device. The identifier may uniquely identify the sales device. The mobile application may be configured to retrieve the receipt data from the server by retrieving data corresponding to a last-generated receipt of the device that is identified by the identifier.

In the method of the first embodiment, the sales device may be located at or near the point of sale of the completed sales transaction. Providing the identifier may include providing a near-field-communication tag that identifies the sales device.

In the method of the first embodiment, the sales device may be located at or near the point of sale of the completed sales transaction. Providing the identifier may include providing the identifier via Bluetooth low-energy technology.

In the method of the first embodiment, the providing the identifier may include providing an identifier of the receipt of the completed sales transaction, the identifier uniquely identifies the receipt, and the mobile application may be configured to retrieve the receipt data from the server by retrieving data corresponding to the receipt that is identified by the identifier.

In the method of the first embodiment, the providing the identifier may include providing the identifier via a Quick-Response code on a printed copy of the receipt.

According to a second embodiment, an apparatus may include at least one processor. The apparatus may also include at least one memory including computer program code. The at least one memory and the computer program code may be configured, with the at least one processor, to cause the apparatus at least to transmit receipt data to a server. The receipt data may reflect a receipt of a completed sales transaction. The apparatus may also be caused to provide an identifier to a mobile application of a customer of the sales transaction. The mobile application may be configured to retrieve the receipt data from the server using the provided identifier. The apparatus may include a sales device.

In the apparatus of the second embodiment, the providing the identifier may include providing an identifier of the apparatus. The identifier uniquely identifies the apparatus. The mobile application may be configured to retrieve the receipt data from the server by retrieving data corresponding to a last-generated receipt of the apparatus that is identified by the identifier.

In the apparatus of the second embodiment, the apparatus may be located at or near the point of sale of the completed sales transaction. Providing the identifier may include providing a near-field-communication tag that identifies the apparatus.

In the apparatus of the second embodiment, the apparatus is located at or near the point of sale of the completed sales transaction. Providing the identifier may include providing the identifier via Bluetooth low-energy technology.

In the apparatus of the second embodiment, the providing the identifier may include providing an identifier of the receipt of the completed sales transaction. The identifier uniquely identifies the receipt. The mobile application may be configured to retrieve the receipt data from the server by retrieving data corresponding to the receipt that is identified by the identifier.

In the apparatus of the second embodiment, the providing the identifier may include providing the identifier via a Quick-Response code on a printed copy of the receipt.

According to a third embodiment, a computer program product may be embodied on a non-transitory computer readable medium, the computer program product may be configured to control a processor to perform a method according to the first embodiment.

According to a fourth embodiment, a method may include receiving, by a mobile application of a customer device, an identifier from a sales device. The customer of the customer device has completed a sales transaction. The method may include retrieving receipt data from a server using the received identifier. The receipt data may reflect a receipt of the completed sales transaction.

In the method of the fourth embodiment, the receiving the identifier may include receiving an identifier of the sales device. The identifier may uniquely identify the sales device, and the mobile application may be configured to retrieve the receipt data from the server by retrieving data corresponding to a last-generated receipt of the device that is identified by the identifier.

In the method of the fourth embodiment, the sales device may be located at or near the point of sale of the completed sales transaction, and receiving the identifier comprises receiving a near-field-communication tag that identifies the sales device.

In the method of the fourth embodiment, the sales device may be located at or near the point of sale of the completed sales transaction, and receiving the identifier may include receiving the identifier via Bluetooth low-energy technology.

In the method of the fourth embodiment, the receiving the identifier may include receiving an identifier of the receipt of the completed sales transaction, the identifier uniquely identifies the receipt, and the mobile application may be configured to retrieve the receipt data from the server by retrieving data corresponding to the receipt that is identified by the identifier.

In the method of the fourth embodiment, the receiving the identifier may include receiving the identifier via a Quick-Response code on a printed copy of the receipt.

According to a fifth embodiment, an apparatus may include at least one processor. The apparatus may include at least one memory including computer program code. The at least one memory and the computer program code may be configured, with the at least one processor, to cause the apparatus at least to receive an identifier from a sales device. The apparatus may also be caused to retrieve receipt data from a server using the received identifier. The receipt data reflects a receipt of a completed sales transaction. The apparatus may include a customer device of a customer of the sales transaction, and the identifier is received via a mobile application of the customer device.

In the apparatus of the fifth embodiment, the receiving the identifier may include receiving an identifier of the sales device. The identifier may uniquely identify the sales device. The mobile application may be configured to retrieve the receipt data from the server by retrieving data corresponding to a last-generated receipt of the device that is identified by the identifier.

In the apparatus of the fifth embodiment, the sales device is located at or near the point of sale of the completed sales transaction. Receiving the identifier may include receiving a near-field-communication tag that identifies the sales device.

In the apparatus of the fifth embodiment, the sales device may be located at or near the point of sale of the completed sales transaction. Receiving the identifier may include receiving the identifier via Bluetooth low-energy technology.

In the apparatus of the fifth embodiment, the receiving the identifier may include receiving an identifier of the receipt of the completed sales transaction. The identifier may uniquely identify the receipt, and the mobile application may be configured to retrieve the receipt data from the server by retrieving data corresponding to the receipt that is identified by the identifier.

In the apparatus of the fifth embodiment, the receiving the identifier may include receiving the identifier via a Quick-Response code on a printed copy of the receipt.

According to a sixth embodiment, a computer program product may be embodied on a non-transitory computer readable medium. The computer program product may be configured to control a processor to perform a method according to the fourth embodiment.

### BRIEF DESCRIPTION OF THE DRAWINGS:

For proper understanding of the invention, reference should be made to the accompanying drawings, wherein:

FIG. 1 illustrates an example system for using near-field communication (NFC) in accordance with certain embodiments.

FIG. 2 illustrates an example server configuration, in accordance with certain embodiments.

FIG. 3 illustrates example tables that are used by a server configuration, when using NFC technologies, in accordance with certain embodiments.

FIG. 4 illustrates an example mobile application configuration in accordance with certain embodiments.

FIG. 5 illustrates example tables that are used by a mobile application configuration, in accordance with certain embodiments.

FIG. 6 illustrates an example system for using Bluetooth low-energy technologies, in accordance with certain embodiments.

FIG. 7 illustrates an example server configuration, when using Bluetooth low-energy technologies, in accordance with certain embodiments.

FIG. 8 illustrates example tables that are used by a server configuration, when using Bluetooth low-energy technologies, in accordance with certain embodiments.

FIG. 9 illustrates an example system that uses Quick Response (QR) code technologies, in accordance with certain embodiments.

FIG. 10 illustrates an example server configuration, when using QR technologies, in accordance with certain embodiments.

FIG. 11 illustrates example tables that are used by a server configuration, when using the Quick Response (QR) code technologies, in accordance with certain embodiments.

FIG. 12 illustrates an example flowchart of a method in accordance with certain embodiments of the invention.

FIG. 13 illustrates an example flowchart of another method in accordance with certain embodiments of the invention.

FIG. 14 illustrates an apparatus in accordance with certain embodiments of the invention.

FIG. 15 illustrates an apparatus in accordance with certain embodiments of the invention.

FIG. 16 illustrates an apparatus in accordance with certain embodiments of the invention.

### DETAILED DESCRIPTION:

Certain embodiments of the present invention may relate to the management of digital receipts. Certain embodiments for managing digital receipts may be directed to an electronic receipt issuing system. The electronic receipt issuing system may include components such as a sales device/terminal, a customer device/terminal, and/or a server configuration.

As described in more detail below, the sales device/terminal may include a receipt data transmitting unit for transmitting a receipt data to the server configuration when a payment is made for a sales transaction. The receipt data of the sales transaction may be transmitted to the server configuration together with an identifier that uniquely identifies the sales device/terminal (where the payment is made). The sales device/terminal may be located at the point of sale. The receipt data of the sales transaction may also include a payment date and a time that represents the date/time that the payment is made.

The customer device/terminal may include a sales device/terminal identifier obtaining unit for obtaining the sales terminal identifier after the payment is made on the sales terminal. The customer terminal may also include a receipt issue requesting unit for transmitting a receipt issue request to the server configuration. The receipt issue request may include the obtained sales device/terminal identifier and a request for the last-generated receipt by the identified sales device/terminal. Alternatively, the receipt issue request may also include a sales device/terminal identifier acquisition date and time that represent the date/time that the sales device/terminal identifier is obtained.

The server configuration may include a receipt data storage unit, a receipt data extracting unit, and/or a receipt data issuing unit. The receipt data storage unit may be configured to store the receipt data that is transmitted by the receipt data transmitting unit of the sales device/terminal in association with the sales terminal identifier and the payment date and time. With certain embodiments, the receipt data extracting unit is configured to extract one of the receipt data stored in the receipt data storage unit only when the sales terminal identifier included in the receipt issue request transmitted by the receipt issue requesting unit of the customer terminal coincides with the sales terminal identifier stored in the receipt data storage unit.

In certain embodiments, the sales terminal identifier obtaining unit may be further configured to obtain the payment date and time after the payment is made on the sales terminal. The receipt issue requesting unit may be configured to transmit the receipt issue request including the sales terminal identifier, the payment date and time, and/or the sales terminal identifier acquisition date and time.

With certain embodiments, the receipt data extracting unit may be configured to extract one of the receipt data stored in the receipt data storage unit only when the sales terminal identifier included in the receipt issue request coincides with the sales terminal identifier stored in the receipt data storage unit.

In certain embodiments of the present invention, the sales terminal may include a wireless communicating unit for transmitting the sales terminal identifier via near field communication. The sales terminal identifier obtaining unit of the customer terminal may be configured to obtain the sales terminal identifier transmitted by the wireless communicating unit after the payment is made on the sales terminal.

In certain embodiments of the present invention, the sales terminal may include a wireless communicating unit for transmitting the sales terminal identifier and the payment date and time via near field communication. The sales terminal identifier obtaining unit of the customer terminal may be configured to obtain the sales terminal identifier and the payment date and time transmitted by the wireless communicating unit after the payment is made on the sales device/terminal.

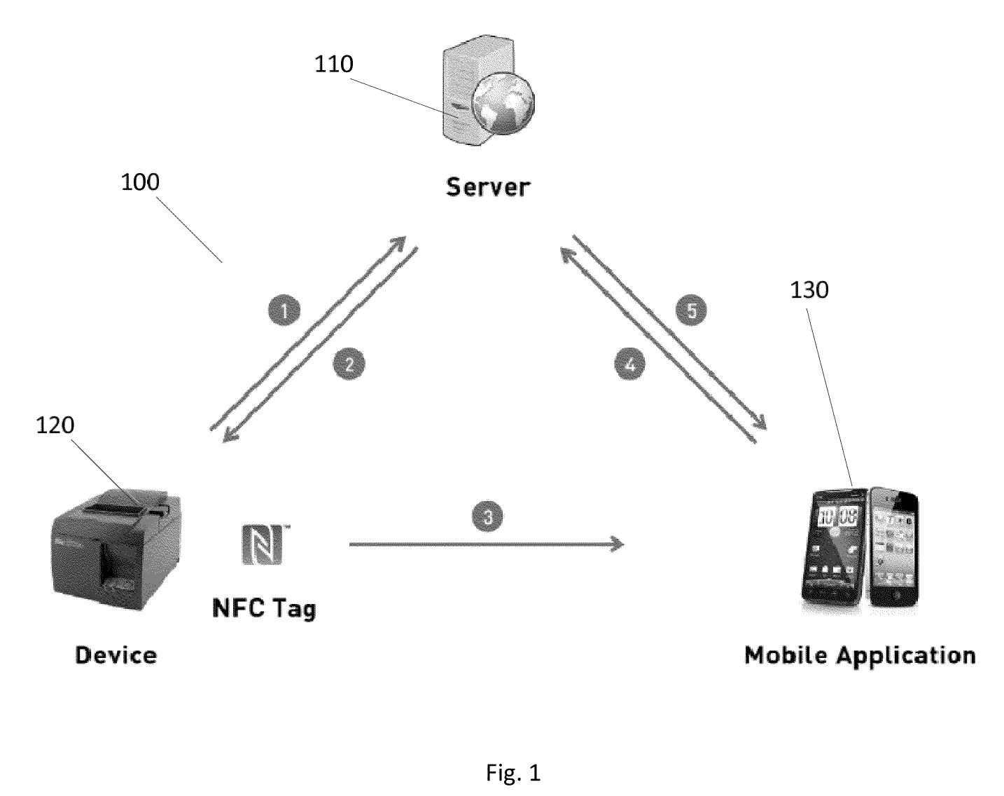

FIG. 1 illustrates an example system 100 for using near-field communication (NFC), in accordance with certain embodiments. As described above, example system 100 may include a payment terminal (such as sales device 120), a customer terminal (such as mobile device/mobile application configuration 130), and/or a server configuration 110. Sales device 120 may be located at the point of sale. The mobile device 130 (upon which the mobile application configuration may be installed) may be a mobile phone, user equipment, tablet, personal digital assistant, and/or any other portable computing device of a customer at the time of sale.

After a customer/user makes a payment and/or completes a sales transaction, at step 1, sales device/terminal 120 may send receipt data (of the completed sales transaction) to server configuration 110. The sent receipt data may reflect the sales of the completed sales transaction. For example, among other types of sales data, the receipt data may include a device identifier that uniquely identifies the sales device/terminal at which the sales transaction occurred (i.e., sales device/terminal 120), a receipt identifier that identifies the specific receipt that corresponds to the completed sales transaction, and/or a receipt content that reflects the sales of the completed sales transaction.

Upon receiving the receipt data from sales terminal/device 120, at step 2, server configuration 110 may send an acknowledgment (i.e., return an “OK”) to sales terminal/device 120.

Next, the customer/user may use mobile device/mobile application configuration 130 to receive an identifying tag that is associated with sales device 120. For example, in certain embodiments, the user may scan/receive an NFC tag associated with sales device 120. Although NFC tags may be used for certain embodiments, other embodiments may use other types of identifying tags, such as Radio-Frequency identification (RFID) tags, smart labels, digital signatures, etc. The identifying tag (such as the NFC tag, for example) may be affixed to the sales device 120, may be transmitted by the sales device 120, or may be in the vicinity of the sales device 120. After scanning the NFC tag associated with sales device 120, at step 3, mobile device/mobile application configuration 130 receives the device identifier that identifies sales device 120.

Next, upon receiving the device identifier (that identifies sales device 120) by mobile device/mobile application configuration 130, at step 4, a mobile application of mobile application configuration 130 may transmit a request to server configuration 110 based on the received identifier. Mobile application configuration 130 may comprise a mobile application that is installed/implemented on a mobile device. Mobile application configuration 130 may transmit a request for retrieval of the last-generated receipt by the sales device identified by the received device identifier (where the received device identifier identifies sales device 120). In other words, mobile application configuration 130 may transmit a request to server configuration 110 to retrieve the last-generated receipt by sales device 120. As such, after a customer/user completes the sales transaction, the customer can retrieve the last-generated sales receipt, which corresponds to the completed sales transaction.

Next, at step 5, server configuration 110 returns receipt data corresponding to the last-generated receipt by sales device 120. The receipt data is transmitted from server configuration 110 to mobile application configuration 130, to be accessed by the user.

With certain embodiments, the device identifier (which identifies sales device 120) and the receipt identifier (which identifies the relevant receipt) may be encrypted. The mobile application and/or the server could decrypt the encrypted data.

By using the above-described NFC tag to retrieve a last-generated receipt, the user may be able to accurately and efficiently retrieve the receipt that reflects the user's sales transaction, as soon as the sales transaction is performed. Further, because the user retrieves the appropriate receipt based upon (1) an identifier that identifies the sales device and (2) the last receipt that was generated by the identified sales device, the user is able to retrieve the appropriate receipt without providing any information that identifies the user. As such, users who do not wish to provide any identifying information may use the above-described method to retrieve their receipts, without providing any information that identifies themselves, and without providing registration/login information to server configuration 110. Further, with certain embodiments, these users may also more conveniently retrieve their receipts by simply scanning/receiving the appropriate NFC tags, and thus the users do not need to manually input any specific information to retrieve their receipts from the server configuration 110.

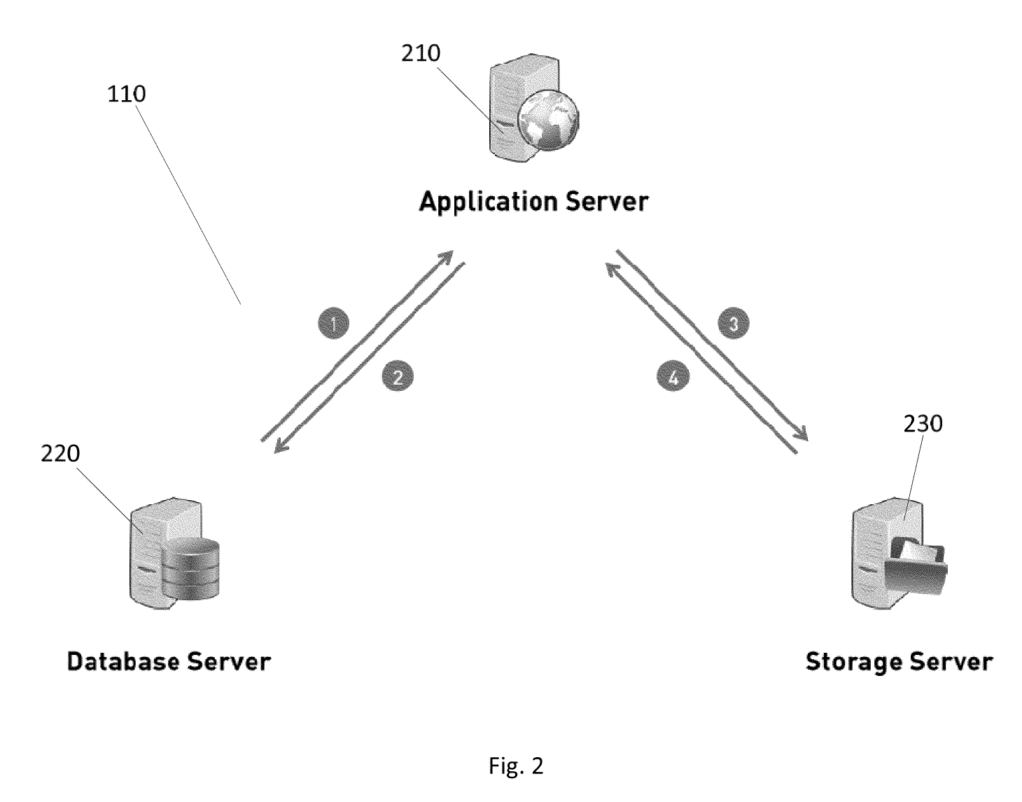

FIG. 2 illustrates an example server configuration, in accordance with certain embodiments. Specifically, FIG. 2 illustrates that server configuration 110 (of FIG. 1) may comprise a plurality of servers such as, for example, application server 210, database server 220, and/or storage server 230. In certain embodiments, application server 210 may provide application programing interfaces (APIs) to mobile applications on mobile devices (such as mobile application 130 of FIG. 1, for example), so that the mobile applications may interact with database server 220 and storage server 230. As such, application server 210 may act as the first interface that the user interacts with on the server-side. Database server 220 may store data about receipts and devices, where this data may be quickly/efficiently referenced. Storage server 230 may store content of receipts in an image or a text format, as described in more detail below. For example, as described in more detail below, database server 220 may store pointers which direct the user to the receipt content that is stored in storage server 230. As such, with certain embodiments, because database server 220 merely stores pointers (or other information that requires less memory), users may quickly/efficiently search through database server 220 for the appropriate pointer that points to the appropriate content stored within storage server 230 (where the content stored within storage server 230 may require more memory). As such, with certain embodiments, the user does not need to directly search through storage server 230, where searching through storage server 230 may be inefficient because the entries within storage server 230 may each occupy more memory. Although the embodiment of FIG. 2 illustrates a database server 220 that is separate from storage server 230, other embodiments may have a single server that performs the functions of both database server 220 and storage server 230.

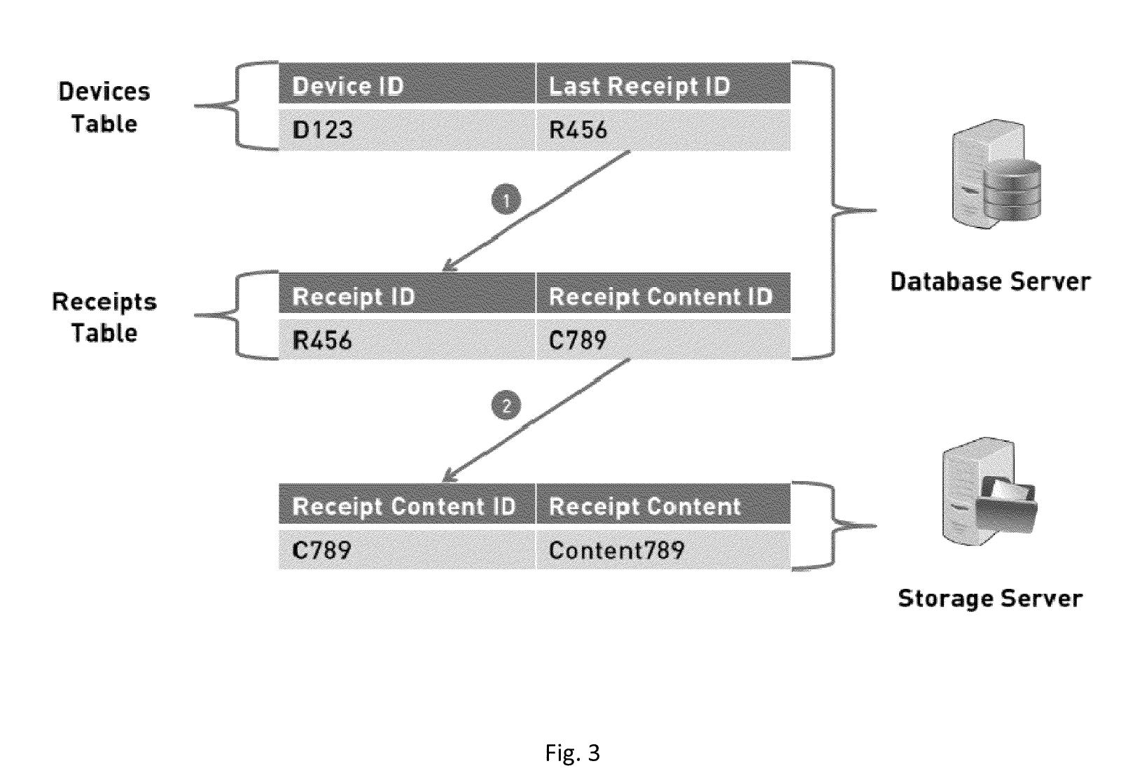

FIG. 3 illustrates example tables that are used by a server configuration, when using NFC technologies (or other types of identifying tags), in accordance with certain embodiments. Specifically, the example tables of FIG. 3 may be the tables that are used by database server 220 and storage server 230 (of server configuration 110). For example, database server 220 may store a devices table that includes different device identifiers, where each device identifier identifies a specific sales device. In the example of FIG. 3, devices table includes a device identifier “D123” that identifies a specific device (such as sales device 120, of FIG. 1, for example). Device identifier “D123” may be associated with a last receipt identifier (such as “R456,” for example), where the last receipt identifier identifies the last receipt that was processed by the sales device corresponding to device identifier “D123.” Last Receipt ID “R456” can act as a pointer to a corresponding receipt content identifier. In the example of FIG. 3, Last Receipt ID “R456” points to receipt content identifier “C789.” Receipt content identifier “C789” can act as a pointer to the actual content of the receipt that is identified by Receipt ID “R456.” For example, receipt content identifier “C789” can point to receipt content “Content789.” As described above, the content may comprise text or a picture that corresponds to the sales transaction.

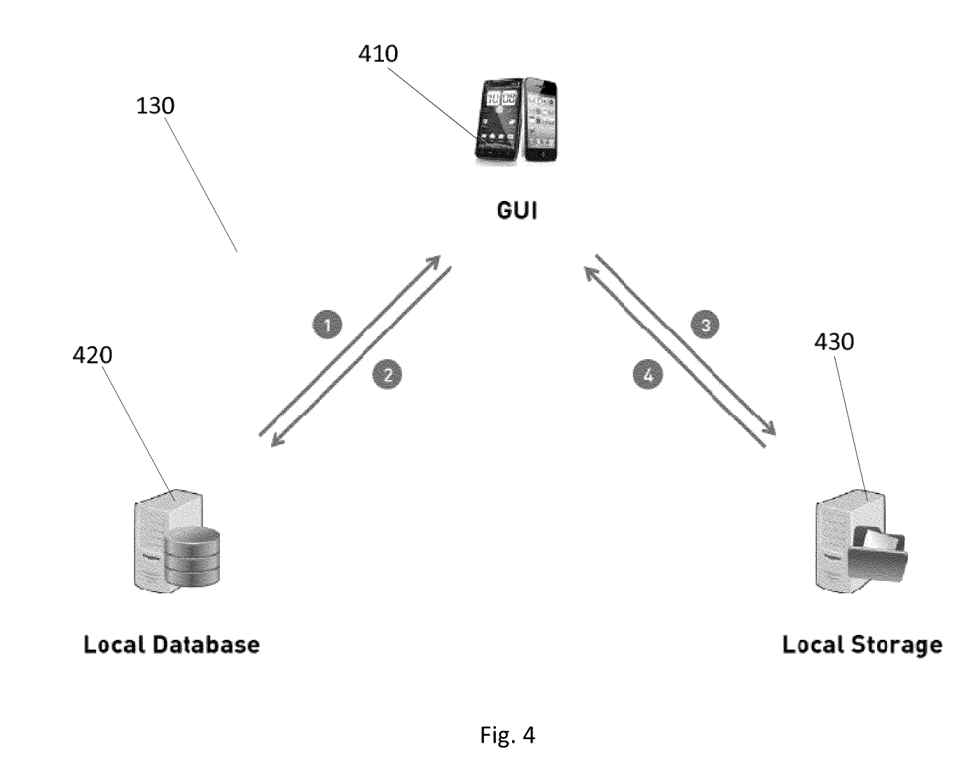

FIG. 4 illustrates an example mobile application configuration 400, in accordance with certain embodiments. For example, the example mobile application configuration may correspond to mobile device/mobile application configuration 130 (of FIG. 1). Referring to FIG. 4, mobile application configuration 130 may include a graphical user interface (GUI) 410. By using GUI 410, a user may access local database 420 and may access local storage 430 via mobile device/application configuration 130. Local database 420 and local storage 430 may both be implemented on the mobile device of the user, for example. Once mobile device/application configuration 130 has received information such as, for example, a device identifier, a receipt identifier, and/or a receipt content identifier, mobile device/application configuration 130 may store these values within local database 420 of the user's mobile device. Local database 420 may be a new database that is generated upon receiving the device identifier, receipt identifier, and/or receipt content identifier. Once the mobile device/application configuration 130 receives a receipt content identifier and corresponding receipt content (for each receipt content identifier), mobile application configuration 130 may store these values within local storage 430, for example.

GUI 410 may include a viewer that enables a user to scan devices/receipts, as described in more detail below. GUI 410 may also include a view to show a list of stored receipts. GUI 410 may retrieve the relevant data from Local Database 420 and Local Storage 430. Local Database 420 may store data about receipts and devices. Local Storage 430 may store receipts' content in image or text format.

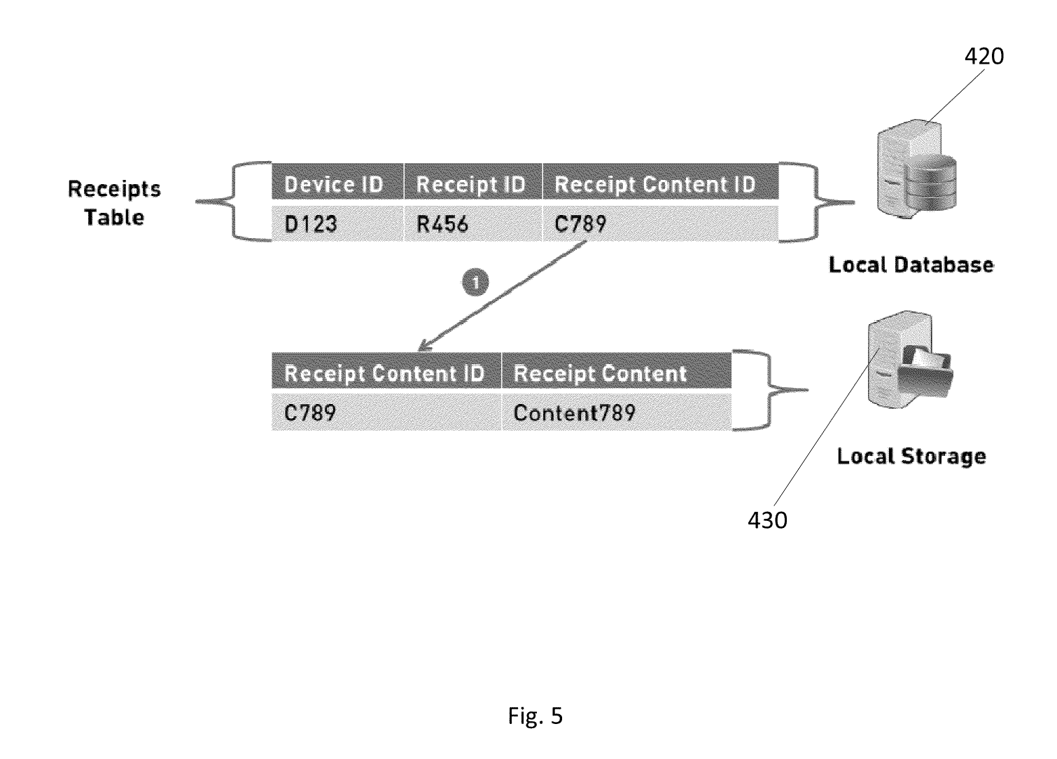

FIG. 5 illustrates example tables that are used by a mobile device/application configuration 130, in accordance with certain embodiments. Referring to FIG. 5, each entry within receipts table may have a corresponding “Device ID” (such as “D123,” for example), “Receipt ID” (such as “R456,” for example), and/or a “Receipt Content ID” (such as “C789,” for example), for example. The “Receipt Content ID” (such as “C789,” for example) may be used as a pointer to retrieve content stored in local storage 430. For example, by using “C789,” at step 1, “Content789” may be retrieved from local storage 430.

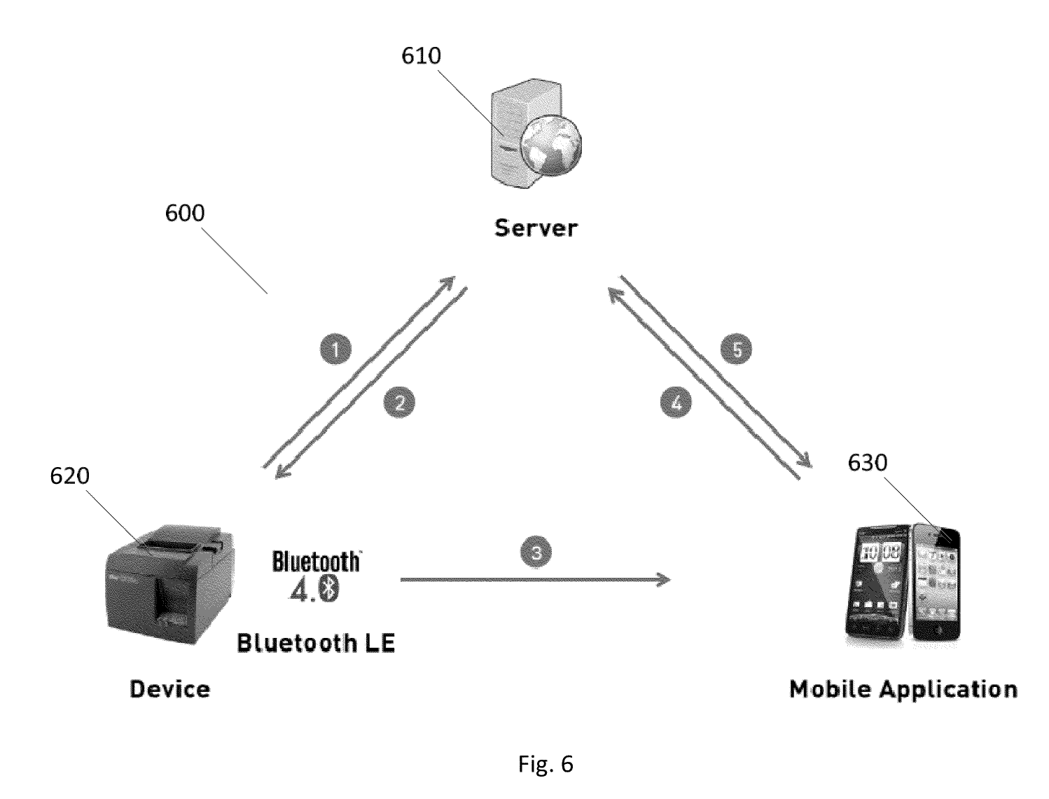

FIG. 6 illustrates an example system 600 for using Bluetooth low-energy technologies, in accordance with certain embodiments. Although Bluetooth low-energy is specifically mentioned, other embodiments may use other types of wireless communication as well (such as personal area networks and Infrared Data Association, for example). As described above with respect to FIG. 1, after a user makes a payment and/or completes a sales transaction, at step 1, sales device 620 may send receipt data to server configuration 610. The sent receipt data may reflect the sales of the completed sales transaction. For example, the receipt data may include a device identifier, a receipt identifier, and/or a receipt content, as described above.

Upon receiving the receipt data, at step 2, server configuration 610 may send an acknowledgment (i.e., return an “OK”) of the received data to sales device 620.

Next, at step 3, a mobile application configuration 630 on the user's mobile device may discover that sales device 620 is nearby, by using Bluetooth low-energy technology. Mobile application configuration 630 may retrieve a device identifier that identifies sales device 620. In contrast to scanning/receiving an NFC tag (as described above with respect to FIG. 1), mobile application configuration 630 can receive the device identifier via Bluetooth communication with sales device 620.

Next, at step 4, mobile application configuration 630 of the user's mobile device may transmit a request to server configuration 610 based on the received identifier. For example, mobile application configuration 630 may transmit a request for retrieval of the last-generated receipt by the device identified by the received device identifier (where the received device identifier identifies sales device 620, for example). In other words, mobile application configuration 630 transmits a request to server configuration 610 to retrieve the last-generated receipt by sales device 620.

Next, at step 5, server configuration 610 returns receipt data corresponding to the last-generated receipt of sales device 620. The receipt data is transmitted from server configuration 610 to the mobile application configuration 630, to be accessed by the user.

As similarly described with respect to the embodiments that use NFC tags to retrieve a last-generated receipt, embodiments of the present invention (that utilize Bluetooth technology) may also allow the user to accurately and efficiently retrieve the receipt that reflects the user's sales transaction, as soon as the sales transaction is performed. Further, because the user retrieves the appropriate receipt based upon (1) an identifier that identifies the sales device (received via Bluetooth technology or via some other wireless communication) and (2) the last receipt that was generated by the identified sales device, the user is able to retrieve the appropriate receipt without providing any information that identifies the user. As such, users who do not wish to provide any identifying information may use the above-described method to retrieve their receipts, without providing any information that identifies themselves, and without providing registration/login information to server configuration 610. As such, with certain embodiments, these users may also more conveniently retrieve their receipts by simply receiving the sales device identifiers using Bluetooth technology, and thus the users do not need to manually input any specific information to retrieve their receipts.

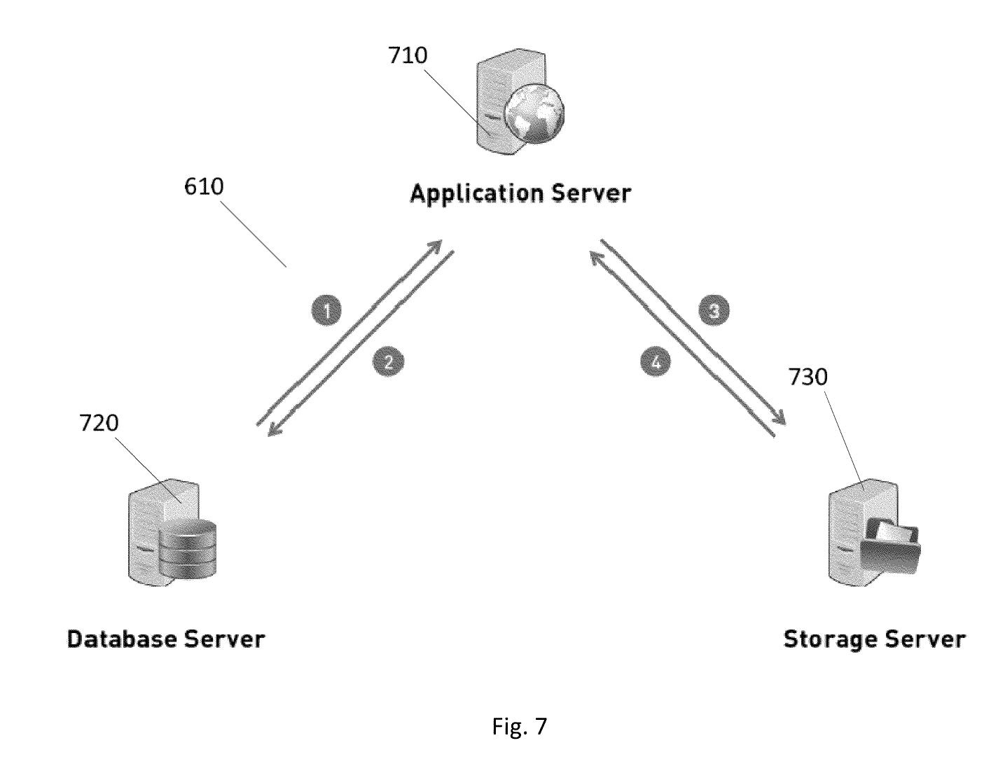

FIG. 7 illustrates an example server configuration 610, when using Bluetooth low-energy technologies, in accordance with certain embodiments. Similar to the above-described server configuration as illustrated by FIG. 2, FIG. 7 illustrates that server configuration 610 (of FIG. 6) may comprise a plurality of servers such as, for example, application server 710, database server 720, and/or storage server 730. In certain embodiments, Application Server 710 may provide application programing interfaces (APIs) to mobile applications on mobile devices (such as mobile application configuration 630, for example), so that the mobile applications may interact with database server 720 and storage server 730. Database server 720 may store data about receipts and devices. Storage server 730 may store content of receipts in an image or a text format, as described in more detail below.

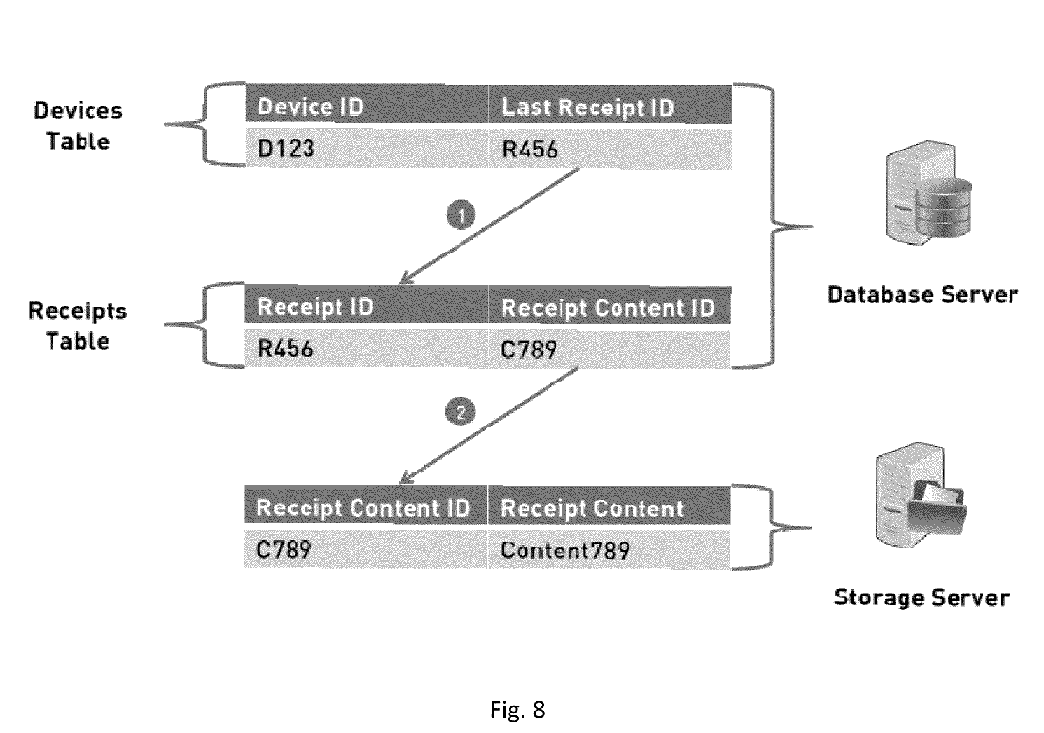

FIG. 8 illustrates example tables that are used by a server configuration, when using Bluetooth low-energy technologies, in accordance with certain embodiments. Specifically, the example tables of FIG. 8 may be the tables that are used by database server 720 and storage server 730. For example, referring to FIG. 8, database server 720 may store a devices table that includes different device identifiers, which each identify a specific sales device. In the example of FIG. 8, devices table includes a device identifier “D123” that identifies a specific device (such as sales device 620, of FIG. 6, for example). Device identifier “D123” may be associated with a last receipt identifier (“R456”), where the last receipt identifier identifies the last receipt that was processed by the sales device of device identifier “D123.” Last Receipt ID “R456” can act as a pointer to a receipt content identifier. In the example of FIG. 8, Last Receipt ID “R456” points to receipt content identifier “C789.” Receipt content identifier “C789” can act as a pointer to the actual content of the receipt that is identified by Receipt ID “R456.” For example, receipt content identifier “C789” can point to the receipt content “Content789.”

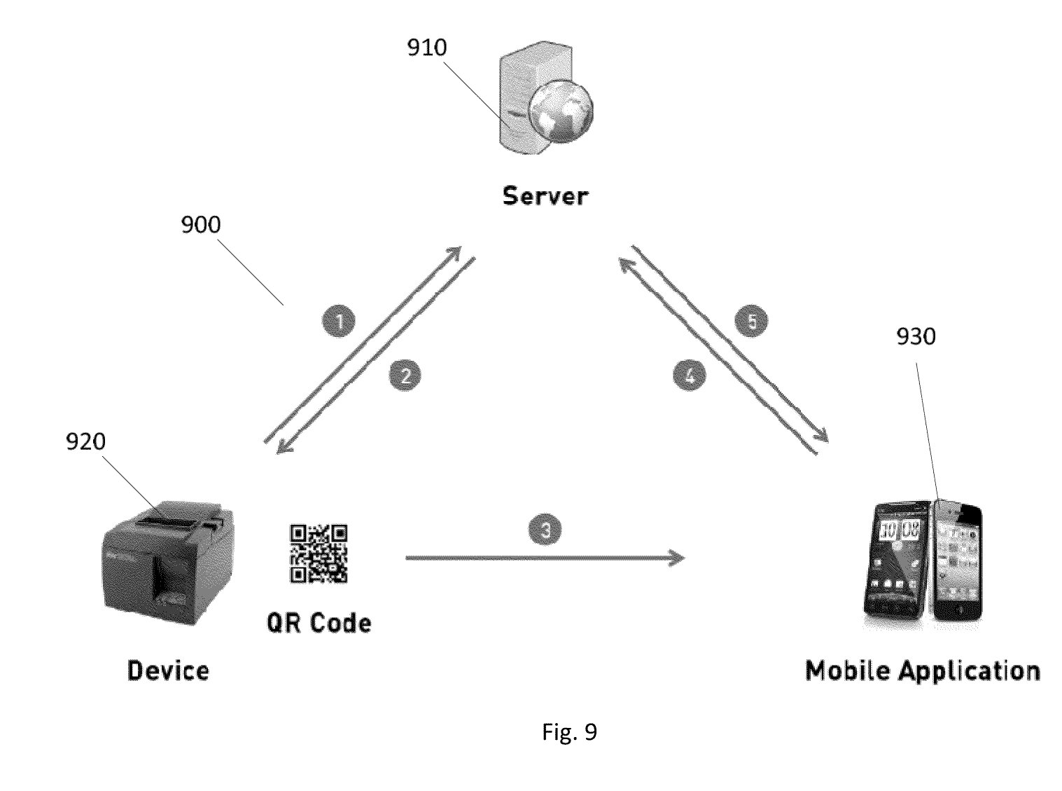

FIG. 9 illustrates an example system for using Quick Response (QR) code technologies, in accordance with certain embodiments. Referring to FIG. 9, after a user makes a payment and/or completes a sales transaction, at step 1, sales device 920 may send receipt data to server configuration 910. The sent receipt data may reflect the sales of the completed sales transaction. For example, the receipt data may include a device identifier that uniquely identifies sales device 920, a receipt identifier that identifies a specific receipt that corresponds to the completed sales transaction, and/or a receipt content that reflects the sales of the completed sales transaction.

Upon receiving the receipt data, at step 2, server configuration 910 may send an acknowledgment (i.e., return an “OK”) of the received receipt data to sales device 920.

After the sales transaction is completed, a physical or electronic receipt may be printed/generated by the sales device 920. The physical receipt may include a printed/generated QR code. As such, at step 3, mobile application configuration 930 of the user's mobile device may scan/access the receipt's QR code, and thus mobile application configuration 930 may retrieve the receipt identifier that identifies the specific receipt. As such, in contrast to the previously described embodiments, mobile application configuration 930 uses a receipt identifier (which is obtained from the QR code) to retrieve the appropriate receipt data, as opposed to using a sales device identifier (as described above with respect to the previously described embodiments).

At step 4, mobile application configuration 930 of the user's mobile device may transmit a request to server configuration 910 based upon the receipt identifier that was retrieved via the QR code. For example, mobile application configuration 930 may request the specific receipt corresponding to the receipt identifier from server configuration 910. At step 5, server configuration 910 may transmit the receipt's data to mobile application configuration 930.

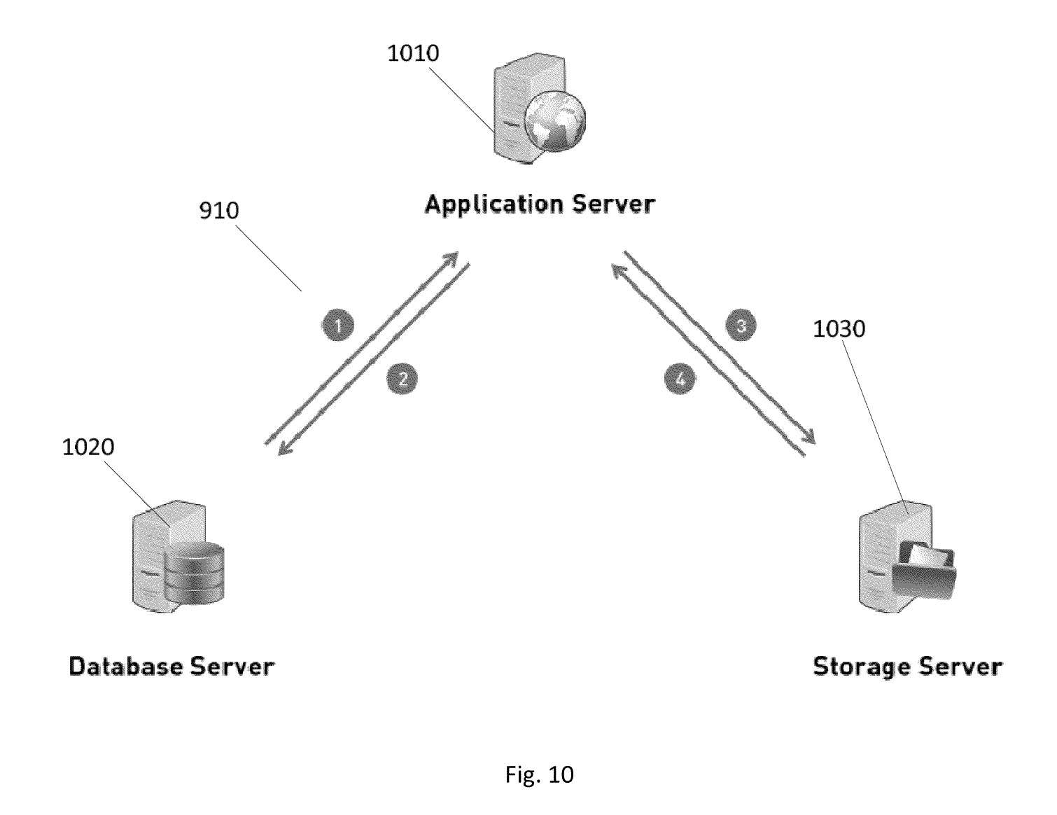

FIG. 10 illustrates an example server configuration 910, when using QR technologies, in accordance with certain embodiments. Similar to the server configurations described above, server configuration 910 of FIG. 9 may also include a database server 1020, an application server 1010, and/or a storage server 1030, for example.

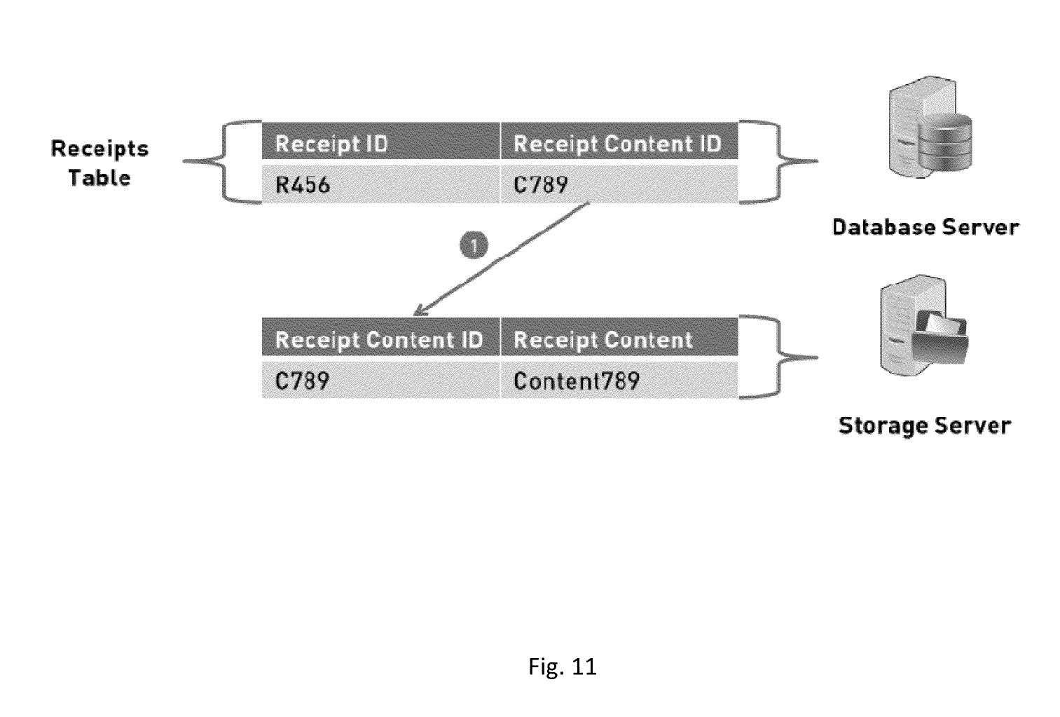

FIG. 11 illustrates example tables that are used by a server configuration, when using the Quick Response (QR) code technologies, in accordance with certain embodiments. Referring to FIG. 11, each entry within receipts table may have a corresponding “Receipt ID” (such as “R456”) and/or a “Receipt Content ID” (such as “C789”), for example. The “Receipt Content ID” (such as “C789,” for example) may be used as a pointer to retrieve content stored in storage server 1030. For example, by using “Receipt Content ID,” at step 1, “Content789” may be retrieved from storage server 1030. In contrast to the previously-described example tables, the example tables of FIG. 11 do not refer to any “last receipt id,” because the embodiment of FIG. 11 directly obtains a receipt identifier from the above-described QR code.

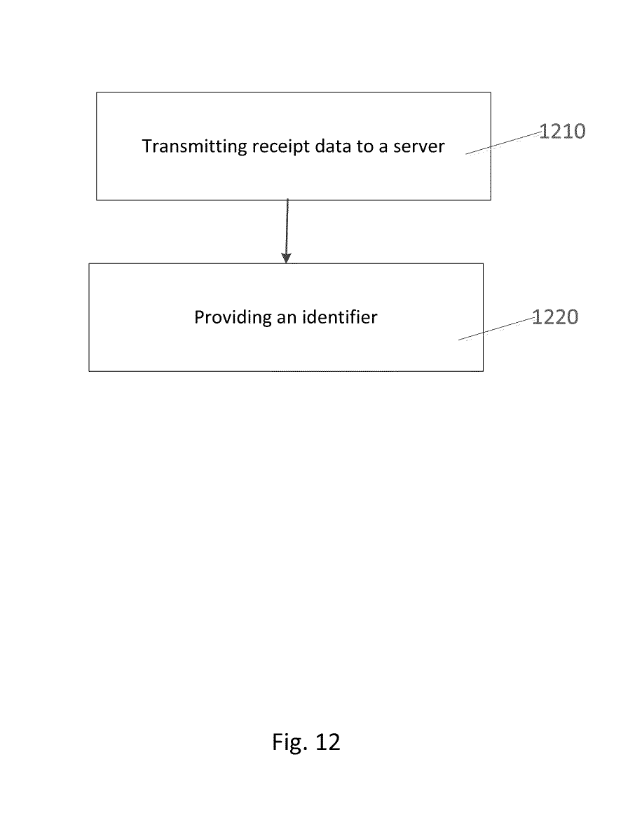

FIG. 12 illustrates an example flowchart of a method, according to one embodiment. The method of FIG. 12 may be performed by a sales device such as, for example, a cash register, a point-of-sale device, a check stand, a credit card terminal, a barcode reader, a product scanner, and/or any other device that enables processing of a sales/commercial transaction. The method illustrated in FIG. 12 includes, at 1210, transmitting, by a sales device, receipt data to a server. The receipt data reflects a receipt of a completed sales transaction. The method may also include, at 1220, providing an identifier to a mobile application of a customer of the sales transaction. The mobile application is configured to retrieve the receipt data from the server using the provided identifier.

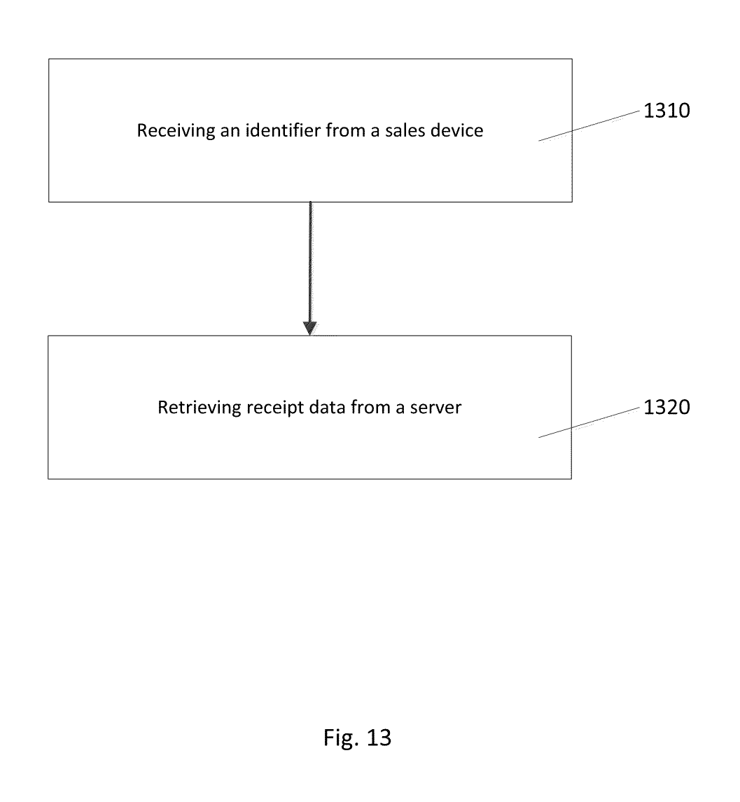

FIG. 13 illustrates an example flowchart of a method, according to another embodiment. The method of FIG. 3 may be performed by a customer device such as a mobile device, portable computing device, tablet device, hand-held phone, laptop computer, and/or any other electronic device that is used by a user/customer. The method illustrated in FIG. 13 includes, at 1310, receiving, by a mobile application of the customer device, an identifier from a sales device. The customer of the customer device has completed a sales transaction. The method may also include, at 1320, retrieving receipt data from a server using the received identifier. The receipt data reflects a receipt of the completed sales transaction.

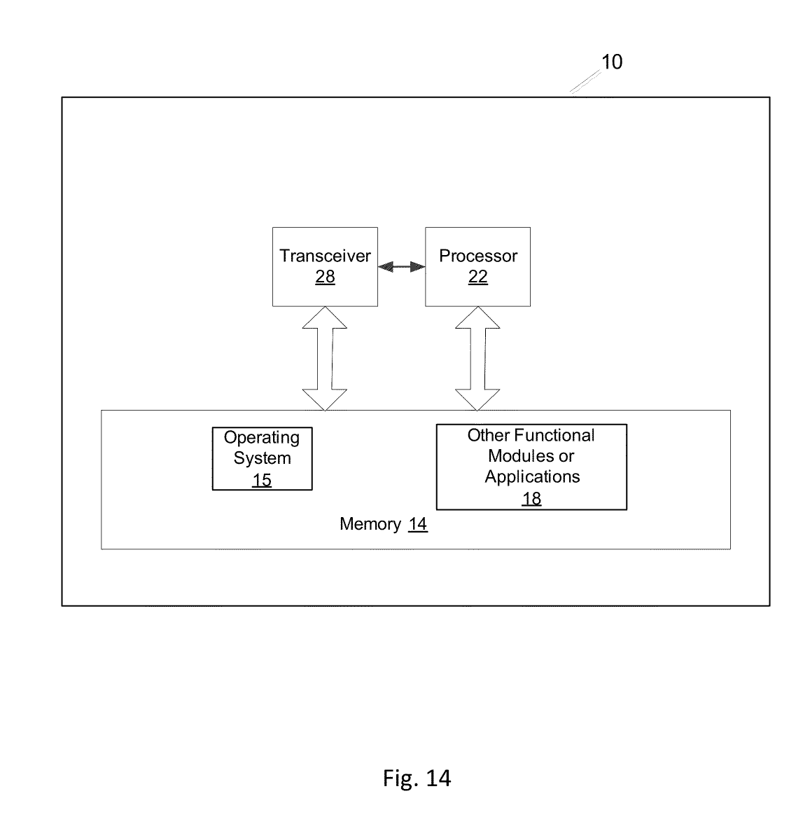

FIG. 14 illustrates an apparatus in accordance with certain embodiments of the invention. In one embodiment, the apparatus can be a sales device, for example. In another embodiment, the apparatus may be a customer device, for example. Apparatus 10 can include a processor 22 for processing information and executing instructions or operations. Processor 22 can be any type of general or specific purpose processor. While a single processor 22 is shown in FIG. 14, multiple processors can be utilized according to other embodiments. Processor 22 can also include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 can further include a memory 14, coupled to processor 22, for storing information and instructions that can be executed by processor 22. Memory 14 can be one or more memories and of any type suitable to the local application environment, and can be implemented using any suitable volatile or nonvolatile data storage technology such as a semiconductor-based memory device, a magnetic memory device and system, an optical memory device and system, fixed memory, and removable memory. For example, memory 14 include any combination of random access memory (RAM), read only memory (ROM), static storage such as a magnetic or optical disk, or any other type of non-transitory machine or computer readable media. The instructions stored in memory 14 can include program instructions or computer program code that, when executed by processor 22, enable the apparatus 10 to perform tasks as described herein.

Apparatus 10 can also include one or more antennas (not shown) for transmitting and receiving signals and/or data to and from apparatus 10. Apparatus 10 can further include a transceiver 28 that modulates information on to a carrier waveform for transmission by the antenna(s) and demodulates information received via the antenna(s) for further processing by other elements of apparatus 10. In other embodiments, transceiver 28 can be capable of transmitting and receiving signals or data directly.

Processor 22 can perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 can store software modules that provide functionality when executed by processor 22. The modules can include an operating system 15 that provides operating system functionality for apparatus 10. The memory can also store one or more functional modules 18, such as an application or program, to provide additional functionality for apparatus 10. The components of apparatus 10 can be implemented in hardware, or as any suitable combination of hardware and software.

In one embodiment, apparatus 10 of FIG. 14 may be configured to transmit receipt data to a server. The receipt data reflects a receipt of a completed sales transaction. Apparatus 10 may also be configured to providing an identifier to a mobile application of a customer of the sales transaction. The mobile application is configured to retrieve the receipt data from the server using the provided identifier.

In another embodiment, apparatus 10 of FIG. 14 may be configured to receiving an identifier from a sales device. Apparatus 10 may also be configured to retrieve receipt data from a server using the received identifier. The receipt data reflects a receipt of a completed sales transaction.

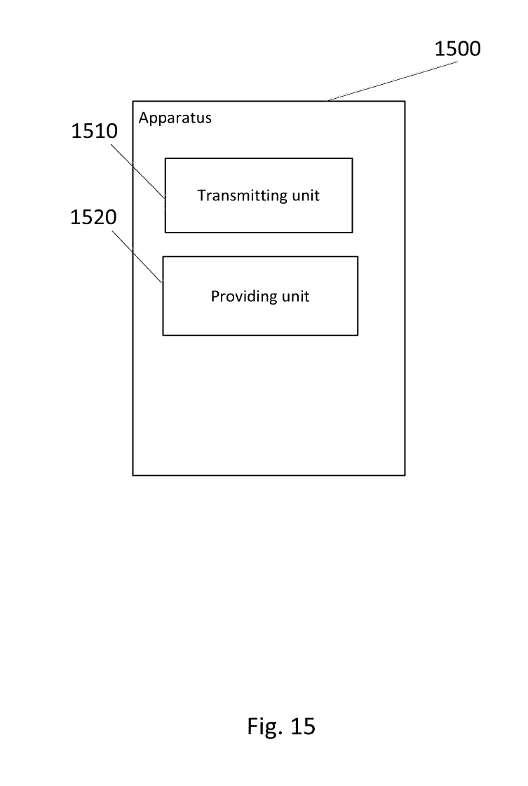

FIG. 15 illustrates an apparatus in accordance with certain embodiments of the invention. Apparatus 1500 can be a sales device, for example. Apparatus 1500 can include a transmitting unit 1510 that transmits receipt data to a server. The receipt data reflects a receipt of a completed sales transaction. Apparatus 1500 may also include a providing unit 1520 that provides an identifier to a mobile application of a customer of the sales transaction. The mobile application is configured to retrieve the receipt data from the server using the provided identifier.

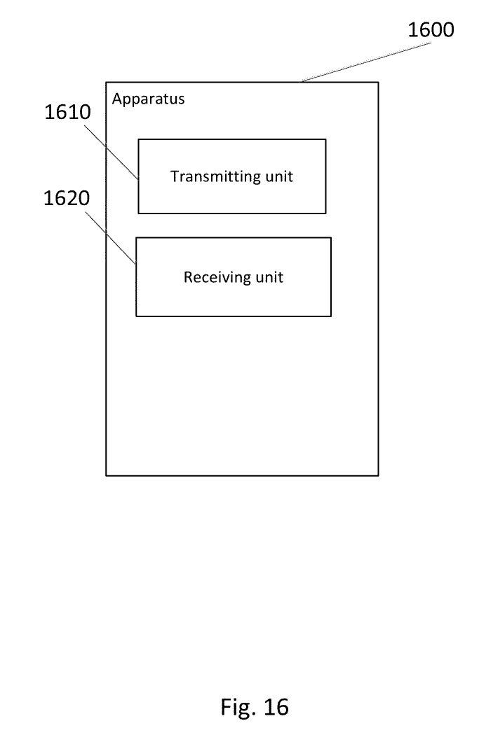

FIG. 16 illustrates an apparatus in accordance with certain embodiments of the invention. Apparatus 1600 can be a customer device, for example. Apparatus 1600 can include a receiving unit 1610 that receives an identifier from a sales device. The customer of the customer device has completed a sales transaction. Apparatus 1600 may also include a retrieving unit that retrieves receipt data from a server using the received identifier. The receipt data reflects a receipt of the completed sales transaction.

In certain embodiments, a computer program product may be embodied on the non-transitory computer readable medium of apparatus 10. The computer program product may be configured to control processor 22 to perform transmitting, by a sales device, receipt data to a server. The receipt data reflects a receipt of a completed sales transaction. The computer program product may also be configured to control processor 22 to perform providing an identifier to a mobile application of a customer of the sales transaction. The mobile application is configured to retrieve the receipt data from the server using the provided identifier.

In other embodiments, a computer program product may be embodied on the non-transitory computer readable medium of apparatus 10. The computer program product may be configured to control processor 22 to perform receiving, by a mobile application of a customer device, an identifier from a sales device. The customer of the customer device has completed a sales transaction. The computer program product may also be configured to control processor 22 to perform retrieving receipt data from a server using the received identifier. The receipt data reflects a receipt of the completed sales transaction.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

We claim:

1. A method, comprising:
transmitting, by a sales device, receipt data to a server, wherein the receipt data reflects a receipt of a completed sales transaction; and
providing an identifier to a mobile application of a customer of the sales transaction, wherein the mobile application is configured to retrieve the receipt data from the server using the provided identifier.

2. The method according to claim 1, wherein the providing the identifier comprises providing an identifier of the sales device, the identifier uniquely identifies the sales device, and the mobile application is configured to retrieve the receipt data from the server by retrieving data corresponding to a last-generated receipt of the device that is identified by the identifier.

3. The method according to claim 2, wherein the sales device is located at or near the point of sale of the completed sales transaction, and providing the identifier comprises providing a near-field-communication tag that identifies the sales device.

4. The method according to claim 2, wherein the sales device is located at or near the point of sale of the completed sales transaction, and providing the identifier comprises providing the identifier via Bluetooth low-energy technology.

5. The method according to claim 1, wherein the providing the identifier comprises providing an identifier of the receipt of the completed sales transaction, the identifier uniquely identifies the receipt, and the mobile application is configured to retrieve the receipt data from the server by retrieving data corresponding to the receipt that is identified by the identifier.

6. The method according to claim 5, wherein the providing the identifier comprises providing the identifier via a Quick-Response code on a printed copy of the receipt.

7. An apparatus, comprising:
at least one processor; and
at least one memory including computer program code,
the at least one memory and the computer program code configured, with the at least one processor, to cause the apparatus at least to
transmit receipt data to a server, wherein the receipt data reflects a receipt of a completed sales transaction; and
provide an identifier to a mobile application of a customer of the sales transaction, wherein the mobile application is configured to retrieve the receipt data from the server using the provided identifier, and the apparatus comprises a sales device.

8. The apparatus according to claim 7, wherein the providing the identifier comprises providing an identifier of the apparatus, the identifier uniquely identifies the apparatus, and the mobile application is configured to retrieve the receipt data from the server by retrieving data corresponding to a last-generated receipt of the apparatus that is identified by the identifier.

9. The apparatus according to claim 8, wherein the apparatus is located at or near the point of sale of the completed sales transaction, and providing the identifier comprises providing a near-field-communication tag that identifies the apparatus.

10. The apparatus according to claim 8, wherein the apparatus is located at or near the point of sale of the completed sales transaction, and providing the identifier comprises providing the identifier via Bluetooth low-energy technology.

11. The apparatus according to claim 7, wherein the providing the identifier comprises providing an identifier of the receipt of the completed sales transaction, the identifier uniquely identifies the receipt, and the mobile application is configured to retrieve the receipt data from the server by retrieving data corresponding to the receipt that is identified by the identifier.

12. The apparatus according to claim 11, wherein the providing the identifier comprises providing the identifier via a Quick-Response code on a printed copy of the receipt.

13. A computer program product, embodied on a non-transitory computer readable medium, the computer program product configured to control a processor to perform a method according to claim 1.

14. A method, comprising:
receiving, by a mobile application of a customer device, an identifier from a sales device, wherein the customer of the customer device has completed a sales transaction; and
retrieving receipt data from a server using the received identifier, wherein the receipt data reflects a receipt of the completed sales transaction.

15. The method according to claim 14, wherein the receiving the identifier comprises receiving an identifier of the sales device, the identifier uniquely identifies the sales device, and the mobile application is configured to retrieve the receipt data from the server by retrieving data corresponding to a last-generated receipt of the device that is identified by the identifier.

16. The method according to claim 15, wherein the sales device is located at or near the point of sale of the completed sales transaction, and receiving the identifier comprises receiving a near-field-communication tag that identifies the sales device.

17. The method according to claim 15, wherein the sales device is located at or near the point of sale of the completed sales transaction, and receiving the identifier comprises receiving the identifier via Bluetooth low-energy technology.

18. The method according to claim 14, wherein the receiving the identifier comprises receiving an identifier of the receipt of the completed sales transaction, the identifier uniquely identifies the receipt, and the mobile application is configured to retrieve the receipt data from the server by retrieving data corresponding to the receipt that is identified by the identifier.

19. The method according to claim 18, wherein the receiving the identifier comprises receiving the identifier via a Quick-Response code on a printed copy of the receipt.

20. An apparatus, comprising:
at least one processor; and
at least one memory including computer program code,
the at least one memory and the computer program code configured, with the at least one processor, to cause the apparatus at least to
receive an identifier from a sales device; and
retrieve receipt data from a server using the received identifier, wherein the receipt data reflects a receipt of a completed sales transaction, the apparatus comprises a customer device of a customer of the sales transaction, and the identifier is received via a mobile application of the customer device.

21. The apparatus according to claim 20, wherein the receiving the identifier comprises receiving an identifier of the sales device, the identifier uniquely identifies the sales device, and the mobile application is configured to retrieve the receipt data from the server by retrieving data corresponding to a last-generated receipt of the device that is identified by the identifier.

22. The apparatus according to claim 21, wherein the sales device is located at or near the point of sale of the completed sales transaction, and receiving the identifier comprises receiving a near-field-communication tag that identifies the sales device.

23. The apparatus according to claim 21, wherein the sales device is located at or near the point of sale of the completed sales transaction, and receiving the identifier comprises receiving the identifier via Bluetooth low-energy technology.

24. The apparatus according to claim 20, wherein the receiving the identifier comprises receiving an identifier of the receipt of the completed sales transaction, the identifier uniquely identifies the receipt, and the mobile application is configured to retrieve the receipt data from the server by retrieving data corresponding to the receipt that is identified by the identifier.

25. The apparatus according to claim 24, wherein the receiving the identifier comprises receiving the identifier via a Quick-Response code on a printed copy of the receipt.

26. A computer program product, embodied on a non-transitory computer readable medium, the computer program product configured to control a processor to perform a method according to claim 18.
